(19) United States
(12) Patent Application Publication
(10) Pub. No.: US 2026/0251187 A1
(43) Pub. Date: Aug. 27, 2026

(54) CLUTCH UNIT FOR REVERSIBLY COUPLING A DRIVE SIDE TO AN OUTPUT SIDE OF A DRIVE TRAIN

(71) Applicant: Schaeffler Technologies AG & Co. KG, Herzogenaurach (DE)

(72) Inventor: Elmar Lorenz, Rheinmünster Söllingen (DE)

(73) Assignee: Schaeffler Technologies AG & Co. KG, Herzogenaurach (DE)

(21) Appl. No.: 18/871,168

(22) PCT Filed: May 15, 2023
(86) PCT No.: PCT/DE2023/100355

§ 371 Date: Dec. 3, 2024

(30) Foreign Application Priority Data
Jun. 13, 2022 (DE) 10 2022 114 774.6

(51) Int. Cl. F16D 25/08; F16D 11/14; F16D 23/14; F16D 25/061; F16D 25/12

(52) U.S. Cl. CPC F16D 25/08; F16D 11/14; F16D 23/14; F16D 25/061; F16D 25/12

(57) ABSTRACT

A clutch unit includes a drive side with a drive element having a drive element outer toothing, an output side with an output element having an output element outer toothing, a linearly movable shift collar having an inner toothing engaged with the drive element outer toothing, and an actuator. The actuator is arranged to displace the shift collar from a decoupling position in which the inner toothing is disengaged from the drive element outer toothing to a coupling position in which the inner toothing is engaged with the output element outer toothing. The actuator includes a linearly movable piston, a shift rod coupled with the piston and the shift collar, and a spring element arranged for axially supporting the piston on the shift rod during linear movement into the coupling position.

### CROSS-REFERENCE TO RELATED APPLICATIONS

This application is the United States National Phase of PCT Appln. No. PCT/DE2023/100355 filed May 15, 2023, which claims priority to German Application No. DE102022114774.6 filed Jun. 13, 2022, the entire disclosures of which are incorporated by reference herein.

### TECHNICAL FIELD

The present disclosure relates to a clutch unit for reversibly coupling a drive side to an output side of a drive train.

### BACKGROUND

Such a clutch unit, often also called a “disconnect unit,” is used, for example, in the drive units of a motor vehicle, such as a drive axle, which can also be an electric axle, often called an e-axle. The clutch unit serves to reversibly couple a drive side, to which a torque is applied, with an output side, to which the torque is to be transmitted and where it is forwarded. For example, it can be arranged between a drive unit and an intermediate shaft in order to couple an outlet of the drive unit, i.e., the drive side, with the inlet of the intermediate shaft, i.e., the output side. An arrangement between such an intermediate shaft and a differential is also conceivable, whereby the intermediate shaft, to which the torque coming from the drive is applied, represents the drive side, while the differential, to which the torque is transmitted, represents the output side. The clutch unit can therefore be integrated into such a drive train at different positions. The clutch unit can be switched in order to achieve or cancel a torque-resistant coupling of the drive side and output side via a controllable switching device, i.e., an actuator.

Such a clutch unit connects two toothed elements on the drive side and the output side, i.e., an externally toothed drive element, for example a first gear, is arranged on the drive side, while an externally toothed output element, for example a second gear, is provided on the output side, which elements are reversibly connected via a coupling element. Such a coupling element is regularly provided in the form of a linearly moveable shift collar, which sits on the drive element, i.e., is provided on the drive side, and engages into the outer toothing of the drive element with the inner toothing. By means of an actuator, the shift collar for coupling the drive side with the output side can be moved along the outer toothing of the drive element and pushed over the output element, so that the inner toothing of the shift collar also engages with the outer toothing of the output element. The drive element and the output element are then coupled together in a rotationally fixed manner via the shift collar that surrounds them both and connects them via the toothed engagement, so that the torque present on the drive side can be transmitted to the output side.

When sliding the shift collar from the drive element to the output element, tooth-to-tooth contact between the inner toothing of the shift collar and the outer toothing of the output element can occur, i.e., the end face of the inner toothing of the shift collar runs onto the end face of the outer toothing of the output element if the toothings do not mesh at the moment of engagement. On the one hand, since the actuator continuously applies a sliding force axially to the shift collar, this leads to a corresponding load on the entire switching system; on the other hand, the engagement process is delayed until there is a gap between the toothing and the inner toothing is pushed into the outer toothing, whereby this sliding process takes place at the actuating speed generally controlled by the actuator.

### SUMMARY

The present disclosure provides an improved clutch unit.

A clutch unit for reversibly coupling a drive side to an output side of a drive train includes a linearly moveable shift collar which is sitting on a drive element of the drive side and engages into an outer toothing of the drive element with an inner toothing, and which can be shifted into a coupling position from a decoupling position, along the outer toothing, via an output element of the drive side, by engaging the inner toothing also into an outer toothing of the output element. An actuator is provided for shifting the shift collar, which has a linearly moveable piston and a shift rod coupled to the piston and connected to the shift collar, and the piston is supported axially on the shift rod via a spring element during a movement into the coupling position.

The present disclosure provides for the integration of a spring element into the switching path of the actuator, whereby this spring element acts on the one hand as a damping element which relieves the switching system in the event of tooth-on-tooth contact and on the other hand serves as an energy storage device via which the shift collar can be moved into the coupling position at a higher speed.

The actuator, may be a hydraulic actuator, has a piston which is mounted in a suitable cylinder housing so that it can be moved linearly. The piston is coupled to a shift rod, which in turn is coupled to the shift collar, which can also be called a sliding collar, for example via a shift fork or similar. If the piston is moved axially when the actuator is activated, the shift rod coupled thereto and therewith the shift fork are moved axially, whereby the shift fork then carries the shift collar therewith and pushes it over the output element, coupling this in the process. According to the disclosure, a spring element is integrated into the coupling of the piston with the shift rod, via which the piston is axially supported during the movement from the end coupling position to the coupling position. This means that the piston moved from the end coupling position works axially against the spring element.

As long as the shift collar can be moved freely, i.e., there is no tooth-to-tooth contact and thus a quasi-axial stop of the shift collar, the shift rod can move freely without compressing the spring element. However, if the shift collar runs against the end face of the outer toothing of the output element, i.e., an axial stop occurs, the piston is displaced further axially while at the same time compressing the spring element, which is supported with respect to the shift rod, which can no longer be displaced axially at that moment. This means that the spring element builds up a restoring force, while at the same time the shift rod is pressed against the output element with only reduced force. As soon as the teeth are back in the gap due to the gear movement, the spring element relaxes, which means that the shift collar is almost suddenly “shot” into the coupling position due to the restoring force. This means that this energy storage device then completes the sudden and therefore significantly faster coupling of the drive side and output side.

The integration of the spring element therefore has a dual function. On the one hand, this integrates a defined flexibility into the actuating system, since the spring element achieves a damping despite further control and movement of the piston and serves as a quasi-chargeable force accumulator, which avoids an excessively high pressure force between the shift collar and the output element in the case of the axial stop described. On the other hand, the force accumulator serves as an additional actuating means, which enables the shift collar to move extremely quickly into the coupling position, as soon as possible, so that it is reached much faster than with previously known systems in which, when the gears are in a gap, reaching the coupling position depends solely on the actuating speed of the actuator, i.e., the piston movement.

The spring element itself is a wave spring or a disc spring, whereby a spring element can also be understood as, for example, two or more wave springs or disc springs connected in series, i.e., a spring package. Such annular-shaped springs achieve a symmetrical axial support, just as the shift rod can be symmetrically acted upon by the actuating force from the energy storage device.

The piston itself is arranged on the shift rod so that it can be moved slightly axially. For this purpose, the piston can be movable along the shift rod between two axial stops provided on the shift rod. The piston therefore has a certain axial play along the shift rod, which allows the piston to be moved slightly further linearly in the event of the shift collar coming into contact with the output element in order to compress the spring element.

In order to achieve a compact design, the spring element is supported by one of the axial stops on this side, while on the other side it is supported directly on the piston. This means that the spring element is integrated directly between such an axial stop and the piston.

Such an axial stop, e.g., both axial stops, can be formed by a retaining ring received in a groove on the shift rod. The axial stops can be easily formed using such retaining rings. Both axial stops may be formed by retaining rings, whereby in principle only one has to be formed in this way, while the other can also be realized by a shoulder formed on the shift rod or similar.

It is conceivable that the spring element rests directly on the retaining ring if the latter is wide enough, when viewed radially. Alternatively, it is conceivable to integrate a supporting disk that rests on the retaining ring and on which the spring element rests, i.e., is axially supported.

In order to make the arrangement compact, the piston may have an annular indentation in which the spring element is received. The annular piston, which has a central through hole through which the shift rod passes, has a corresponding annular indentation which opens into the through hole. The annular spring element can now be arranged in this indentation so that it is ultimately integrated into the piston. The piston can be pushed over the axial stop or the retaining ring, which can even be adjacent to it in the decoupling position or can be accommodated in the annular indentation, depending on how deep this is or how long the piston is, when viewed axially.

The actuator itself may be a hydraulically controllable actuator, which can therefore be positioned axially by means of a fluid. The piston may be activated in both directions via the fluid. This means that to move from the decoupling to the coupling position, the fluid on one side of the piston is guided into the cylinder housing or the pressure chamber until the piston or the shift collar is in the coupling position. To move from the coupling to the decoupling position, the fluid is guided to the other side of the piston or into the pressure chamber of the cylinder housing there, so that the piston and with it the shift rod and shift collar are moved back axially. Every marked position is therefore actively controlled and approached. In this way, the coupling and decoupling function can be realized as a “normally stay” function. This is because the piston remains in the respective position, i.e., either the decoupling position or the coupling position, without a continuous pressure build-up via the actuating hydraulics, which enables more efficient switching operation, for example with regard to the “sailing function” of a motor vehicle, in which there is no coupling, but also no energy expenditure is required to maintain this decoupling situation.

In order to realize this actuating function of the actuator in both directions, a first sealing element is provided sealing the piston towards the shift rod and a second sealing element is provided sealing the piston towards a wall of a cylinder guiding the piston. These two sealing elements define two pressure chambers, one in front of and one behind the piston, and seal them against each other. The piston movement depends on whether the fluid is pressed into the pressure chamber in front of or the piston chamber behind the piston. Suitable sealing rings or similar are used as sealing elements.

The clutch unit is designed as a damped system which reduces the system stress or component stress in the event of tooth-on-tooth contact, i.e., axial contact of the shift collar against the output element. At the same time, better and faster engagement is achieved, resulting from the use of the spring element as an energy or force accumulator, via which the shift collar can be moved extremely quickly into the coupling position, while the rigidity of the system is also improved.

Furthermore, the present disclosure relates to a drive train, e.g., of a motor vehicle, including a drive element and an output element and a reversibly coupling clutch unit of the manner described above.

### BRIEF DESCRIPTION OF THE DRAWINGS

The present disclosure is explained below on the basis of exemplary embodiments with reference to the drawings. The drawings are schematic representations, in which:

FIG. 1 shows a schematic diagram of a clutch unit according to the disclosure, and

FIG. 2 shows an enlarged partial view of the actuator of the clutch unit with the integrated spring elements.

### DETAILED DESCRIPTION

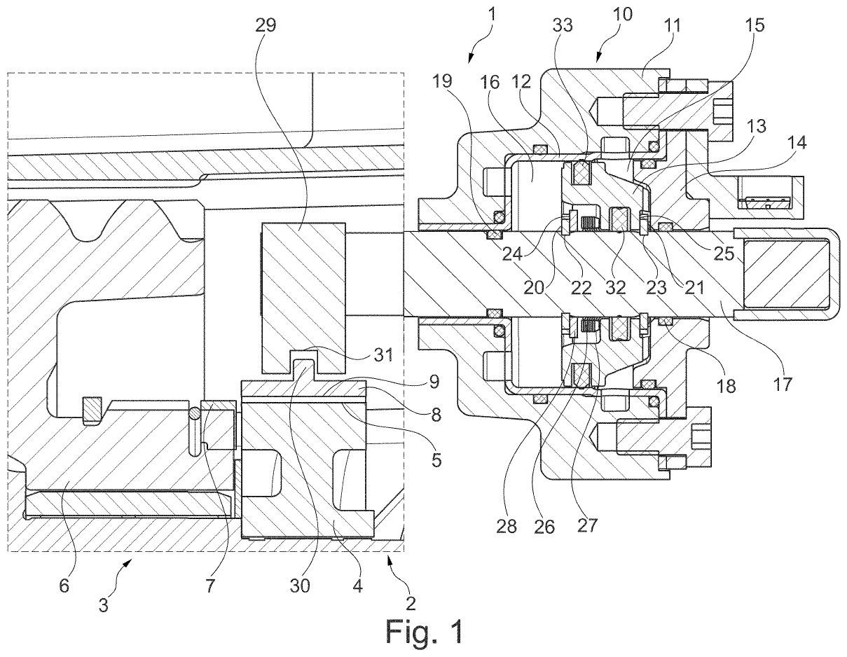

FIG. 1 shows a schematic diagram of a clutch unit 1 according to the present disclosure, which can also be referred to as a coupling device, and which serves to couple a drive side 2, at which a torque is introduced or is present, with an output side 3, to which the torque is to be transmitted and where it is further branched. On the drive side 2, a drive element 4 is provided which has an outer toothing 5. The drive element 4 is, for example, a gear or externally toothed shaft.

On the output side 3, an output element 6 is provided which has an outer toothing 7, whereby this output element 6 can also be a gear or an externally toothed shaft or the like. The outer toothings 5, 7 are linear radial toothings that have the same pitch and are located on the same radius. In order to couple the drive element 4 with the output element 6 in a rotationally fixed manner, a shift collar 8 is provided which is axially displaceable. It has an inner toothing 9 with which it completely engages with the outer toothing 5 of the drive element 4 in the decoupling position shown in FIG. 1. This means that, in the decoupling position, the shift collar 8 is only coupled to the drive element 4. A torque transfer to the output element 6 is not possible in this position. However, if a torque transfer is to take place, it is necessary to move the shift collar 8 axially and to push it over the output element 6 or its outer toothing 7, so that the inner toothing 9 of the shift collar 8 is pushed into the outer toothing 7 and meshes therewith. At the same time, the engagement of the inner toothing 9 with the outer toothing 5 remains, so that the drive element 4 and the output element 6 are coupled in a rotationally fixed manner via the shift collar 8.

In order to realize this movement of the shift collar 8, an actuator 10 is provided, which is a hydraulic actuator. It has a housing 11, in which a cylindrical insert 12 made of sheet metal is accommodated, which forms a guide cylinder and in which a piston 13 is arranged. The housing 11 is closed axially by a cover 14. Within the cylinder insert 12, the piston 13 is axially displaceable via a hydraulic fluid, for which purpose a first pressure chamber 15 is provided which is realized between the piston 13 and the cover 14. On the opposite side, a second pressure chamber 16 is realized, which is realized between the piston 13 and the end wall of the insert 12. Depending on which pressure chamber 15, 16 the hydraulic fluid is pressed into, the piston is moved in one direction or the other.

Furthermore, a shift rod 17 is provided, which extends through the housing 11 and is sealed thereto via corresponding sealing elements 18, 19. The shift rod 17 is axially movable, for which purpose it is coupled to the piston 13. For this purpose, two axial stops 20, 21 are provided on the shift rod 17, which are realized via two retaining rings 24, 25 received in respective grooves 22, 23. Between these axial stops 20, 21, the piston 13 can be slightly axially displaced.

This axial displacement is possible against a spring element 26, which is designed as a wave spring or disc spring or as a corresponding spring package and is accommodated in an annular indentation 27 of the piston. On the one hand, the spring element 26 is supported on the piston 13 or the bottom of the indentation 27, see FIG. 1, and on the other hand on the axial stop 20 or a supporting disk 28 supported on the snap ring 24. If a fluid is pressed into the pressure chamber 15, the piston 13 is displaced to the left until the spring element 26 rests against the supporting disk 28, unless this is already the case.

The shift rod 17 is further connected to a carrier 29, for example a shift fork, which in turn is connected to the shift collar 8 via a corresponding form-fitting engagement. For this purpose, the shift collar 8 rotating with the drive element 4 has, for example, a circumferential annular projection 30 which engages in a corresponding receiving groove 31 on the shift fork 29.

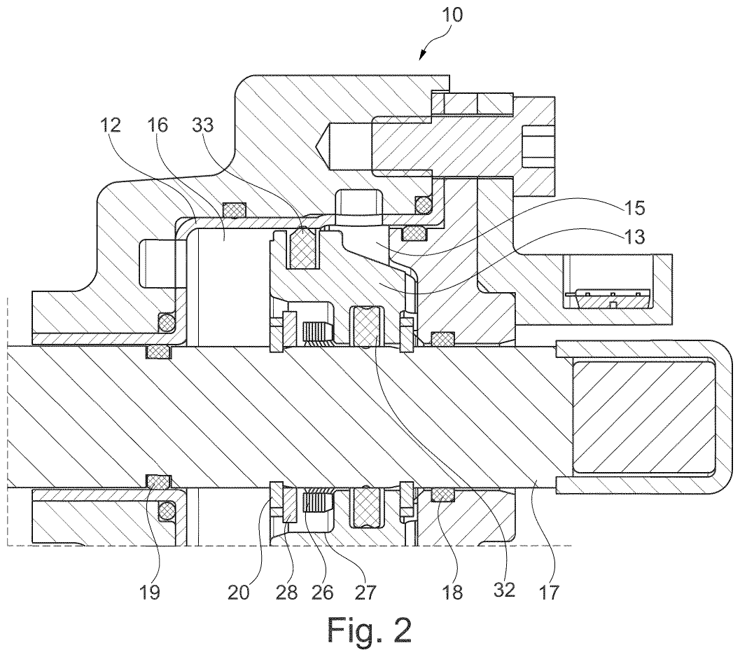

FIG. 2 shows a part of the actuator 10 in an enlarged view. The piston 13 is shown enlarged with the pressure chamber 15 on the right side and the pressure chamber 16 on the left side. In order to seal this also towards the piston side, two sealing elements 32, 33 are provided on the piston, via which a seal is provided on the one hand to the shift rod 17 and on the other hand to the cylinder insert 12.

The spring element 26 and the annular indentation 27 in which it is held are also shown enlarged. As FIG. 2 shows, the piston 13 in the decoupling position shown in FIGS. 1 and 2 even extends over the stop element 20 and the supporting disk 28, which means that these are also accommodated in the indentation 27 in the decoupling position, thus providing a compact design.

If a torque-resistant coupling is to be achieved starting from the decoupling position shown in the figures, in which the drive element 4 is not coupled to the output element 6, the hydraulic fluid is pressed into the pressure chamber 15. The piston 13 moves to the left. In this case, the shift rod 17 is driven after the spring element 26 is supported on the axial stop 20 and the piston 13 runs against the spring element 26. In the event that the outer toothings 5, 7 are spaced apart, the shift collar 8 can be easily pushed over the outer toothing 7 or the inner toothing 9 can be meshed with the outer toothing 7. The hydraulic actuation continues until the coupling position is reached, in which the piston 13 moves, for example, to a left stop position at the bottom of the cylinder insert 12.

However, if the outer toothing 5, 7 is not aligned, the inner toothing 9 of the shift collar will inevitably run with its end side against the end side of the outer toothing 7 of the output element 6, thus creating an axial stop. In this case, after the hydraulic fluid is still pressed into the pressure chamber 15 under pressure, the piston 13 is pushed further axially, wherein no further axial displacement of the shift rod 17 is possible due to the stop. However, the piston 13 can continue to move due to its axial play or its axial mobility; at the same time, the spring element 26 is compressed and a restoring force builds up. The spring element 26 therefore serves as a force accumulator. On the one hand, this dampens the stop movement after damping or flexibility is integrated into the actuating system via the spring element 26, so that the component load in this actuating system is reduced. At the same time, the spring element 26 acts as an energy storage device, as previously mentioned.

As soon as the movement of the drive element 4 relative to the output element 6 results in a situation in which the outer toothing 5, 7 aligns again and the inner toothing 9 can therefore be pushed into the outer toothing 7, the spring element 26 relaxes abruptly and shoots the shift rod and via this the shift collar 8 in the direction of the output element 6, thus pushing the shift collar 8 over the output element 6 and bringing the toothing 7, 9 into engagement. Due to the use of the energy stored in the spring element 26, this process occurs more quickly than it would be possible to achieve solely via the hydraulic actuating effect of the piston 13 if the piston 13 was rigidly connected to the shift rod 17.

In the coupling position, the piston 13 no longer needs to be pressurized since the actuator is a double-sided actuator and due to the use of corresponding axial toothings, the arrangement remains in the adopted coupling position. No additional energy expenditure is required to maintain this situation. If the coupling position is to be released again, i.e., the shift collar 8 is to be pushed back again, the fluid is pressed into the second pressure chamber 16 so that the piston 13 and with it the shift rod 17 together with the shift collar 8 are pushed to the right again and the toothed engagement of the shift collar 8 with the output element 6 is released again.

### REFERENCE NUMERALS

1 Clutch unit
2 Drive side
3 Output side
4 Drive element
5 Outer toothing
6 Output element
7 Outer toothing
8 Shift collar
9 Inner toothing
10 Actuator
11 Housing
12 Cylinder insert
13 Piston
14 Cover
15 Pressure chamber
16 Pressure chamber
17 Shift rod
18 Sealing element
19 Sealing element
20 Axial stop
21 Axial stop
22 Groove
23 Groove
24 Retaining ring
25 Retaining ring
26 Spring element
27 Indentation
28 Supporting disk
29 Carrier
30 Annular projection
31 Shift fork
32 Sealing element
33 Sealing element

1. A clutch unit for reversibly coupling a drive side to an output side of a drive train, the clutch unit comprising a linearly moveable shift collar which is sitting on a drive element of the drive side and engages into an outer toothing of the drive element with an inner toothing, and which can be shifted into a coupling position from a decoupling position, along the outer toothing, via an output element of the output side, by engaging the inner toothing also into an outer toothing of the output element, wherein an actuator is provided for shifting the shift collar, the actuator comprising a linearly moveable piston and a shift rod coupled to the piston and coupled to the shift collar, wherein the piston is supported axially on the shift rod via a spring element during a movement into the coupling position.

2. The clutch unit according to claim 1, wherein the spring element is a wave spring or a disc spring.

3. The clutch unit according to claim 1, characterized in wherein the piston is movable along the shift rod between two axial stops provided on the shift rod.

4. The clutch unit according to claim 3, wherein one side of the spring element is supported on the piston the other side of the spring element is supported via one of the two axial stops.

5. The clutch unit according to claim 3, wherein the two axial stops, are formed by respective retaining rings received in respective grooves on the shift rod.

6. The clutch unit according to claim 5, further comprising a supporting disk, against which the spring element rests, that rests on one of the respective retaining rings.

7. The clutch unit according to claim 1, wherein the piston has an annular indentation, in which the spring element is accommodated.

8. The clutch unit according to claim 1, wherein the actuator is a hydraulically controllable actuator.

9. The clutch unit according to claim 8, further comprising a first sealing element arranged for sealing the piston towards the shift rod and a second sealing element arranged for sealing the piston towards a wall of a cylinder guiding the piston.

10. A drive train for a motor vehicle, comprising a drive element and an output element and the clutch unit of claim 1 reversibly coupling the drive element and the output element.

11. A clutch unit comprising:
a drive side comprising a drive element, the drive element comprising a drive element outer toothing;
an output side comprising an output element, the output element comprising an output element outer toothing;
a linearly movable shift collar arranged on the drive element, the shift collar comprising an inner toothing engaged with the drive element outer toothing; and
an actuator arranged to displace the shift collar from a decoupling position in which the inner toothing is disengaged from the drive element outer toothing to a coupling position in which the inner toothing is engaged with the output element outer toothing, the actuator comprising:
a linearly movable piston;
a shift rod coupled with the piston and the shift collar; and
a spring element arranged for axially supporting the piston on the shift rod during linear movement into the coupling position.

12. The clutch unit of claim 11, wherein the spring element is a wave spring or a disc spring.

13. The clutch unit of claim 11, wherein
the shift rod comprises two axial stops; and
the piston is linearly movable between the two axial stops.

14. The clutch unit of claim 13, wherein:
one side of the spring element is supported on the piston; and
the other side of the spring element is supported on one of the two axial stops.

15. The clutch unit of claim 14, wherein:
the piston comprises an annular indentation; and
the spring element is supported by the annular indentation.

16. The clutch unit of claim 13, wherein the two axial stops are formed by respective retaining rings received in respective grooves of the shift rod.

17. The clutch unit of claim 16, further comprising a supporting disk arranged between the spring element and the one of the two axial stops.

18. The clutch unit of claim 11, wherein the actuator is hydraulically controlled.

19. The clutch unit of claim 18, further comprising:
a cylinder comprising a wall for guiding the piston;
a first sealing element for sealing the piston to the shift rod; and
a second sealing element for sealing the piston to the wall.
